(19) United States
(12) Patent Application Publication
(10) Pub. No.: US 2025/0207063 A1
(43) Pub. Date: Jun. 26, 2025

(54) UNIT DOSE DETERGENT PACKS

(71) Applicant: Henkel AG & Co. KGaA, Duesseldorf (DE)

(72) Inventor: Daniel Thomas Piorkowski, Fairfield, CT (US)

(21) Appl. No.: 18/971,030

(22) Filed: Dec. 6, 2024

Related U.S. Application Data
(60) Provisional application No. 63/612,416, filed on Dec. 20, 2023.

(51) Int. Cl. C11D 3/22; C11D 1/831; C11D 3/20; C11D 17/04

(52) U.S. Cl. CPC C11D 3/221; C11D 1/831; C11D 3/2065; C11D 17/043; C11D 2111/12; C11D 2111/14

(57) ABSTRACT

Single unit dose detergent packs are provided including a pouch formed from a film polymer and a liquid detergent composition releasably disposed within the pouch. The liquid detergent composition is free of propylene glycol and includes an alditol as a sustainable solvent ingredient.

### CROSS REFERENCE TO RELATED APPLICATION

This application claims priority to and the benefit of U.S. Provisional Patent Application No. 63/612,416, filed Dec. 20, 2023. The related application is incorporated herein in its entirety by reference.

### TECHNICAL FIELD

The present disclosure relates to household and industrial cleaning, in particular unit dose detergent packs containing liquid detergent compositions.

### BACKGROUND

Single dose detergent packs for laundry and dish washing are popular with consumers for their convenience. The wash composition may be in one of several available formats, including tablet, granules, paste, liquid, or gel. Unit dose detergent packs containing liquid detergent encapsulated in a polymer film provide quick delivery and dispersibility of detergent in wash water even in a cool or cold-water washing process. The pre-measured quantity of detergent in a unit dose minimizes waste, avoids spillage and mess, and is easy to store and use. Consumers further find such packs to be aesthetically pleasing.

Single dose liquid detergent packs require the use of a balance of water and non-aqueous solvents to maintain the wash composition in the form of a solution. Additionally, the liquid detergent must be compatible with the encapsulating film that forms the exterior of the pack. The film must not prematurely dissolve, and its integrity and physical appearance should not be adversely affected by the detergent. Historically, glycerol, polyethylene glycol 400, and propylene glycol have been used as non-aqueous solvents in liquid detergent packs. However, propylene glycol is an allergen which may cause contact dermatitis in individuals who have sensitive skin and are exposed to the compound (2018 Allergen of the Year, American Contact Dermatitis Society).

Many consumers seek products that use sustainable materials. Consumers further seek cleaning products that have the appearance of quality and are made from ingredients that do not form unsightly discoloration over time or under conditions of use.

Thus, there is a need in the art for new, single dose liquid detergent packs containing cost effective and sustainable ingredients while providing pack integrity and quality. There is further need in the art for such packs that are hypoallergenic.

### SUMMARY

Disclosed, in various embodiments, are unit dose detergent packs comprising a liquid detergent composition free of propylene glycol.

In an embodiment, a unit dose detergent pack comprises a pouch formed from a water-soluble or water-dispersible film; and a liquid detergent composition free of propylene glycol and releasably disposed within the pouch, the liquid detergent composition comprising: a detergent surfactant system in an amount of about 10 to about 60 wt %; water in an amount of about 5 to about 35 wt %; and a non-aqueous solvent system comprising a C₄₋₁₂ alditol in an amount of about 3 to about 20 wt %, a polyethylene glycol having a number average molecular weight of from about 100 to about 1500 Daltons in an amount of about 3 to about 35 wt %, and glycerol in an amount of about 0 to about 20 wt %, wherein all amounts are based on the total weight of the liquid detergent composition, and the C₄₋₁₂ alditol and the polyethylene glycol are present in a weight ratio of about 10:90 to about 90:10.

In another embodiment, a unit dose detergent pack comprises a pouch formed from a polyvinyl alcohol film; and a liquid detergent composition free of propylene glycol and releasably disposed within the pouch, the liquid detergent composition comprising: a detergent surfactant system in an amount of about 10 to about 60 wt %; water in an amount of about 5 to about 25 wt %; and a non-aqueous solvent system comprising sorbitol in an amount of about 3 to about 20 wt %, a polyethylene glycol having a number average molecular weight of from about 200 to about 800 Daltons in an amount of about 3 to about 35 wt %, and glycerol in an amount of about 0 to about 20 wt %, wherein all amounts are based on the total weight of the liquid detergent composition, and the sorbitol and the polyethylene glycol are present in a weight ratio of about 10:90 to about 90:10.

These and other features and characteristics are more particularly described below.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

Disclosed, in various embodiments, are unit dose detergent packs comprising a pouch formed from a water-soluble or water-dispersible film and a liquid detergent composition releasably disposed within the pouch. The liquid detergent composition is free of propylene glycol, an allergen compound which may cause contact dermatitis in sensitive individuals. Such consumers would prefer using packs that are hypoallergenic. The solvents used in the liquid detergent compositions of the unit dose detergent packs described herein comprise water and non-aqueous solvents, such as glycerol and/or polyethylene glycol, and further comprise a C₄₋₁₂ alditol. The use of the C₄₋₁₂ alditol in the solvent system of the liquid detergent compositions results in detergent formulations that are stable liquids and compatible with the pack's polymer film. C₄₋₁₂ alditols advantageously are sustainable and sourced from renewable materials including biomass. Certain alditols are also cost effective and may be used to replace some portion of other non-aqueous solvents used in the liquid formulation. For example, sorbitol can be prepared from the hydrogenation of glucose. Sorbitol is more cost effective than PEG 400 and thus the amount of PEG 400 in a liquid detergent composition can be reduced and replaced with sorbitol. Likewise, a portion or all of the glycerol in a formulation can be replaced with sorbitol.

The liquid detergent composition of the unit dose detergent pack comprises a detergent surfactant system, water, and a non-aqueous solvent system.

### Detergent Surfactant System

The detergent surfactant system is present in the liquid detergent composition in an amount of about 10 to about 60 wt % based on the total weight of the liquid detergent composition, specifically about 15 to about 55 wt %, more specifically about 20 to about 50 wt %, yet more specifically about 25 to about 45 wt %, and still more specifically about 30 to about 40 wt %.

The detergent surfactant system can comprise a non-ionic surfactant, an anionic surfactant, a cationic surfactant, an ampholytic surfactant, a zwitterionic surfactant, or a combination thereof. In an embodiment, the detergent surfactant system comprises a non-ionic surfactant, an anionic surfactant, or a combination of a non-ionic surfactant and an anionic surfactant. In another embodiment, the detergent surfactant system consists of a non-ionic surfactant and an anionic surfactant.

Suitable non-ionic surfactants include alkyl glycosides and ethoxylation and/or propoxylation products of alkyl glycosides or linear or branched alcohols in each case having 12 to 18 carbon atoms in the alkyl moiety and 3 to 20, or 4 to 10, alkyl ether groups. Corresponding ethoxylation and/or propoxylation products of N-alkylamines, vicinal diols, fatty acid esters and fatty acid amides, which correspond to the alkyl moiety in the stated long-chain alcohol derivatives, may furthermore be used. Alkylphenols having 5 to 12 carbon atoms may also be used in the alkyl moiety of the above described long-chain alcohol derivatives.

Examples of suitable non-ionic surfactants include, but are not limited to, polyalkoxylated alkanolamides, polyoxyalkylene alkyl ethers, polyoxyalkylene alkylphenyl ethers, polyoxyalkylene sorbitan fatty acid esters, polyoxyalkylene sorbitol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, amine oxide surfactants, alkoxylated fatty alcohols, or a combination thereof. In some embodiments, the nonionic surfactant is an alcohol alkoxylate such as alcohol ethoxylate, alcohol propoxylate, or a combination thereof.

The alcohol ethoxylate may be primary and secondary alcohol ethoxylates, specifically the C₈-C₂₀ aliphatic alcohols ethoxylated with an average of 1 to 20 moles of ethylene oxide per mole of alcohol, and more specifically the C₁₀-C₁₅ primary and secondary aliphatic alcohols ethoxylated with an average of 1 to 10 moles, or 3 to 8 moles of ethylene oxide per mole of alcohol.

Exemplary alcohol ethoxylates are the condensation products of aliphatic C₈-C₂₀, specifically C₈-C₁₆, primary or secondary, linear or branched chain alcohols with ethylene oxide. In some embodiments, the alcohol ethoxylates contain 1 to 20, or 3 to 8 ethylene oxide groups, and may optionally be end-capped by a hydroxylated alkyl group.

In one embodiment, the alcohol ethoxylate has Formula (I):

R¹—(—O—C₂H₄—)ₘ—OH (I)

wherein R¹ is a hydrocarbyl group having 8 to 16 carbon atoms, 8 to 14 carbon atoms, 8 to 12 carbon atoms, or 8 to 10 carbon atoms; and m is from 1 to 20, or 3 to 8.

The hydrocarbyl group may be linear or branched, and saturated or unsaturated. In some embodiments, R¹ is a linear or branched C₈-C₁₆ alkyl or a linear group or branched C₈-C₁₆ alkenyl group. Specifically, R¹ is a linear or branched C₈-C₁₆ alkyl, C₈-C₁₄ alkyl, or C₈-C₁₀ alkyl group. In case (e.g., commercially available materials) where materials contain a range of carbon chain lengths, these carbon numbers represent an average. The alcohol may be derived from natural or synthetic feedstock. In one embodiment, the alcohol feedstock is coconut, containing predominantly C₁₂-C₁₄ alcohol, and oxo C₁₂-C₁₅ alcohols.

Suitable anionic surfactants include soaps which contain sulfate or sulfonate groups, including those with alkali metal ions as cations. Usable soaps include alkali metal salts of saturated or unsaturated fatty acids with 12 to 18 carbon atoms. Such fatty acids may also be used in incompletely neutralized form. Usable ionic detergent surfactants of the sulfate type include the salts of sulfuric acid semi esters of fatty alcohols with 12 to 18 carbon atoms, and/or alcohol ethoxysulfates. Usable ionic detergent surfactants of the sulfonate type include alkane sulfonates with 12 to 18 carbon atoms and olefin sulfonates with 12 to 18 carbon atoms, such as those that arise from the reaction of corresponding mono-olefins with sulfur trioxide, alpha-sulfofatty acid esters such as those that arise from the sulfonation of fatty acid methyl or ethyl esters, and lauryl ether sulfates.

In some embodiments, the anionic surfactant is a polyethoxylated alcohol sulfate. Such materials, also known as alkyl ether sulfates or alkyl polyethoxylate sulfates, are those which correspond to the following formula (II):

R²—O—(C₂H₄O)ₙ—SO₃M′ (II)

wherein R² is a C₈-C₂₀ alkyl group, n is from 1 to 20, and M′ is a salt-forming cation, specifically R² is C₁₀-C₁₈ alkyl, n is from 1 to 15, and M′ is sodium, potassium, ammonium, alkylammonium, or alkanolammonium. In another embodiment, R² is a C₁₂-C₁₆ alkyl, n is from 1 to 6 and M′ is sodium. In another embodiment, the alkyl ether sulfate is sodium lauryl ether sulfate.

In some embodiments, the anionic surfactant can be linear alkylbenzene sulfonic acid or a salt thereof, alkyl propoxy sulfate, alkyl sulfate, or a combination thereof. Linear alkylbenzenesulfonate is a water soluble salt of a linear alkyl benzene sulfonate having between 8 and 22 carbon atoms of the linear alkyl group. The salt can be an alkali metal salt, or an ammonium, alkylammonium, or alkanolammonium salt. In one embodiment, the linear alkylbenzenesulfonate comprises an alkali metal salt of C₁₀-C₁₆ alkyl benzene sulfonic acids, such as C₁₁-C₁₄ alkyl benzene sulfonic acids.

In an embodiment, the detergent surfactant system comprises an anionic surfactant that is a polyethoxylated alcohol sulfate or a linear alkyl benzene sulfonic acid and a non-ionic surfactant that is an alcohol alkoxylate.

### Water

Water is present in the liquid detergent composition in an amount of about 5 to about 35 wt % based on the total weight of the liquid detergent composition, specifically about 8 to about 25 wt %, more specifically about 10 to about 20 wt %, and still more specifically about 12 to about 18 wt %. Water may be added to the liquid detergent composition directly, added as a component of one or more other ingredients, or added both directly and as a component of another ingredient.

### Non-Aqueous Solvent System

The non-aqueous solvent system comprises a C₄₋₁₂ alditol and a polyethylene glycol. The non-aqueous solvent system optionally further comprises glycerol. The C₄₋₁₂ alditol and the polyethylene glycol are present in a weight ratio of about 10:90 to about 90:10, specifically about 30:70 to about 70:30, more specifically about 40:60 to about 60:40, and yet more specifically about 50:50.

The non-aqueous solvent system comprises a C₄₋₁₂ alditol present in the liquid detergent composition in an amount of about 3 to about 20 wt %, based on the total weight of the liquid detergent composition, specifically about 5 to about 17 wt %, more specifically about 8 to about 15 wt %, and yet more specifically about 10 to about 13 wt %.

The C₄₋₁₂ alditol can be sorbitol, adonitol (ribitol), arabitol, dulcitol (galactitol), erythritol, inositol, isomalt, maltitol, mannitol, xylitol, or a combination thereof. In an embodiment, the C₄₋₁₂ alditol comprises no reducing sugars or substantially no reducing sugars. As used herein “the C₄₋₁₂ alditol comprises no reducing sugars” means it contains 0% total reducing sugars and “the C₄₋₁₂ alditol comprises substantially no reducing sugars” means it may contain up to about 0.5% reducing sugar based on the weight of the alditol. In an embodiment, the C₄₋₁₂ alditol contains 0 to about 0.5% reducing sugar, specifically about 0 to about 0.15% total reducing sugars.

Reducing sugars, such as glucose and fructose, contain aldehyde or ketone groups that can react with amines, including amino acids, in the Maillard Reaction resulting in browning, particularly at elevated temperatures. Such reactions result in undesirable yellowing or browning discoloration. Alditols are non-reducing sugars and will not take part in the Maillard Reaction, thus avoiding the potential for discoloration of the liquid detergent composition while in the unit pack or while in use.

Sorbitol is produced from glucose derived from renewable sources and is a non-reducing sugar. Some grades of sorbitol contain residual amounts of glucose that when formulated into a detergent composition, the glucose may take part in a Maillard Reaction with amines present in the detergent composition or introduced in the wash system. Grades of sorbitol that are free or substantially free of glucose and other reducing sugars are desirable, particularly when clear, undyed detergent compositions are to be produced to avoid yellowing and discoloration of the composition as well as the items to be washed.

In an embodiment, the C₄₋₁₂ alditol is sorbitol. In a further embodiment, the sorbitol comprises no reducing sugars or substantially no reducing sugars.

The polyethylene glycol (PEG) used in the liquid detergent composition can have a number average molecular weight of about 100 to about 1500 Daltons, specifically about 200, about 300, about 400, about 500, about 600, about 700, about 800, about 900, about 1000, about 1100, about 1200, about 1300, about 1400 Daltons. In an embodiment, the polyethylene glycol has a number average molecular weight of about 200 to about 800 Daltons.

The polyethylene glycol can be present in an amount of about 3 to about 35 wt % based on the total weight of the liquid detergent composition, specifically about 5 to about 30 wt %, more specifically about 10 to about 25 wt %, yet more specifically about 12 to about 20 wt %, and still more specifically about 15 to about 18 wt %.

Besides a C₄₋₁₂ alditol and a polyethylene glycol, the non-aqueous solvent system may comprise glycerol in an amount of about 0 to about 20 wt % based on the total weight of the liquid detergent composition, specifically about 5 to about 17 wt %, more specifically about 8 to about 16 wt %, and yet more specifically about 10 to about 14 wt %.

### Additional Ingredients

The liquid detergent composition may further comprise one or more additional ingredients. Such non-limiting ingredients include an antimicrobial agent, an anti-redeposition agent, a biodegradable polymer, a bittering agent, a bleach activator, a chelating agent, a colorant (including dyes, pigments, and the like), an enzyme, a foam inhibitor, a fragrance (also referred to as “perfume”), a neutralizer, an optical brightener, a performance polymer, a peroxy compound, a soil releasing polymer, a whitener, or a combination thereof.

Exemplary antimicrobial agents include an agent effective against gram-positive and gram negative bacteria, yeast, or mold.

The liquid detergent composition may optionally contain an anti-redeposition agent, which includes polymers with a soil detachment capacity, which are also known as “soil repellents” due to their ability to provide a soil-repelling finish on the treated surface, such as a fiber. Exemplary anti-redeposition agent polyesters include copolyesters prepared from dicarboxylic acids, such as adipic acid, phthalic acid or terephthalic acid. In an exemplary embodiment, an anti-redeposition agent includes polyesters with a soil detachment capacity that include those compounds which, in formal terms, are obtainable by esterifying two monomer moieties, the first monomer being a dicarboxylic acid HOOC-Ph-COOH and the second monomer a diol HO—(CHR³—)_{q}OH, which may also be present as a polymeric diol H—(O—(CHR³—)_{q})_{b}OH. Ph here means an ortho-, meta- or para-phenylene residue that may bear 1 to 4 substituents selected from alkyl residues with 1 to 22 carbon atoms, sulfonic acid groups, carboxyl groups, or a combination thereof. R³ means hydrogen or an alkyl residue with 1 to 22 carbon atoms, or a combination thereof. “q” means a number from 2 to 6 and “b” means a number from 1 to 300. The polyesters obtainable therefrom may contain not only monomer diol units —O—(CHR³—)ₜO— but also polymer diol units —(O—(CHR³—)_{q})_{b}O—. The molar ratio of monomer diol units to polymer diol units may amount to from about 100:1 to about 1:100, or from about 10:1 to about 1:10 in another embodiment. In the polymer diol units, the degree of polymerization “b” may be in the range of from about 4 to about 200, or from about 12 to about 140 in an alternate embodiment. The average molecular weight of the polyesters with a soil detachment capacity may be in the range of from about 250 to about 100,000, or from about 500 to about 50,000 in an alternate embodiment. The acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid, or a combination thereof. Where the acid groups thereof are not part of the ester bond in the polymer, they may be present in salt form, such as an alkali metal or ammonium salt. Exemplary embodiments include sodium and potassium salts.

If desired, instead of the monomer HOOC-Ph-COOH, the polyester with a soil detachment capacity (the anti-redeposition agent) may include small proportions, such as no more than about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR³—)_{q}OH include those in which R³ is hydrogen and “q” is a number of from about 2 to about 6, and in another embodiment includes those in which “q” has the value of 2 and R³ is selected from hydrogen and alkyl residues with 1 to 10 C atoms, or where R³ is selected from hydrogen and alkyl residues with 1 to 3 C atoms in another embodiment. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols include polyethylene glycol with an average molar mass in the range from about 1000 to about 6000. If desired, these polyesters may also be end group-terminated, with end groups that may be alkyl groups with 1 to 22 carbon atoms or esters of monocarboxylic acids. The end groups attached via ester bonds may be based on alkyl, alkenyl and aryl monocarboxylic acids with 5 to 32 carbon atoms, or with 5 to 18 carbon atoms in another embodiment. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, crucic acid, brassidic acid, clupanodonic acid, lignoceric acid, cerotic acid, melissic acid, benzoic acid, which may bear 1 to 5 substituents having a total of up to 25 carbon atoms, or 1 to 12 carbon atoms in another embodiment, for example tert-butylbenzoic acid. The end groups may also be based on hydroxymonocarboxylic acids with 5 to 22 carbon atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or in the range of from 1 to 10 in another embodiment. In an exemplary embodiment, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, are used alone or in combination with cellulose derivatives. In certain embodiments, the anti-redeposition agent is a biopolymer or in part derived from a plant or other biological material.

The anti-redeposition agent may be present in the liquid detergent composition at an amount of about 0 to about 3 wt % based on the total weight of the liquid detergent composition, specifically about 0 to about 2 wt %, or more specifically about 0 to about 1 wt %.

Biodegradable polymers that can provide the liquid detergent composition with enhanced performance properties, such as enhanced cleaning, prevention of dye transfer, anti-redeposition, etc. may be added to the composition. Exemplary biodegradable polymers include biodegradable graft polymers and biodegradable graft copolymers.

The liquid detergent composition may further comprise a bittering agent added to hinder accidental ingestion of the unit dose detergent pack or the liquid detergent composition. Bittering agents are compositions that taste bad, so children or others are discouraged from accidental ingestion. Exemplary bittering agents include denatonium benzoate, aloin, and others.

A bittering agent may be present in the liquid detergent composition in an amount of about 0 to about 1 wt % based on the total weight of the liquid detergent composition, specifically about 0 to about 0.5 wt %, or more specifically about 0 to about 0.1 wt %.

Bleach activators may optionally be added to the liquid detergent composition. Conventional bleach activators that form peroxycarboxylic acid or peroxyimidic acids under perhydrolysis conditions and/or conventional bleach-activating transition metal complexes may be used. The bleach activator may include, but is not limited to, one or more of: N- or O-acyl compounds, for example polyacylated alkylenediamines, such as tetraacetylethylenediamine; acylated glycolurils, such as tetraacetylglycoluril; N-acylated hydantoins; hydrazides; triazoles; urazoles; diketopiperazines; sulfurylamides and cyanurates; carboxylic anhydrides, such as phthalic anhydride; carboxylic acid esters, such as sodium isononanoylphenolsulfonate; acylated sugar derivatives, such as pentaacetyl glucose; and cationic nitrile derivatives such as trimethylammonium acetonitrile salts.

To avoid interaction with peroxy compounds during storage, the bleach activators may be coated with shell substances or granulated prior to addition to the detergent composition, in a known manner. As such, the bleach activator and/or other components may be present in the composition as a free or floating particulate. Exemplary embodiments of the coating or shell substance include tetraacetylethylenediamine granulated with the assistance of carboxymethylcellulose and having an average grain size of 0.01 mm to 0.8 mm, granulated 1,5-diacetyl-2,4-dioxohexahydro-1,3,5-triazine, and/or trialkylammonium acetonitrile formulated in particulate form. In alternative embodiments, the bleach activators may be enclosed in a compartment, separate from the compartment that contains peroxy compounds and/or other compounds of the liquid detergent composition.

The bleach activators may be present in the liquid detergent composition in an amount of about 0 to about 8 wt % based on the total weight of the liquid detergent composition, specifically about 0 to about 6 wt %, and more specifically about 0 to about 4 wt %.

Chelating agents may optionally be added to the liquid detergent composition to bind and remove calcium, magnesium, or other metals from water. Exemplary chelating agents include ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, iminodisuccinic acid (IDS), or a combination thereof.

Chelating agents may be present in the liquid detergent composition in an amount of about 0 to about 5 wt % based on the total weight of the liquid detergent composition, specifically about 0.01 to about 3 wt %, more specifically about 0.02 to about 1 wt %.

Suitable enzymes that may be in the liquid detergent composition include a protease, lipase, cutinase, amylase, carbohydrase, cellulase, pectinase, mannanase, arabinase, galactanase, xylanase, oxidase, (e.g., a laccase), and/or peroxidase, but others are also possible. In general, the properties of a selected enzyme should be compatible with the selected liquid detergent composition, (i.e., pH-optimum, compatibility with other enzymatic and non-enzymatic ingredients, etc.).

The enzyme may be present in the liquid detergent composition in an amount of about 0 to about 5 wt % based on the total weight of the liquid detergent composition, specifically about 0.001 to about 1 wt %, more specifically about 0.2 to about 2 wt %, and yet more specifically about 0.5 to about 1 wt %.

The foam inhibitor can be a fatty acid. Exemplary fatty acids have the formula: R⁴—C(O)OH, wherein R⁴ is a C₅-C₂₄ linear or branched aliphatic group, specifically R⁴ is a C₁₃-C₂₁ linear or branched aliphatic group, and more specifically the fatty acid is dodecanoic acid (also known as coconut fatty acid).

The foam inhibitor can be present in an amount of about 0 to about 5 wt % based on the total weight of the liquid detergent composition, specifically about 0.05 to about 4 wt %, and more specifically about 0.5 to about 3 wt %.

Exemplary neutralizers include sodium hydroxide, triethanol amine, monoethanol amine, buffers, or other compounds that adjust the pH of the composition.

Neutralizers may be present in an amount of about 0 to about 5 wt % based on the total weight of the liquid detergent composition, specifically about 0 to about 3 wt %, and mor specifically about 0 to about 2 wt %.

Optical brighteners adsorb ultraviolet and/or violet light and re-transmit it as visible light, typically a visible blue light. Optical brighteners include, for example, derivatives of diaminostilbene disulfonic acid or the alkali metal salts thereof. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl.

Optical brighteners may be present in the liquid detergent composition in an amount of about 0 to about 1 wt % based on the total weight of the liquid detergent composition, specifically about 0.01 to about 0.5 wt %, and more specifically about 0.05 to about 0.3 wt %.

Suitable performance polymers include alkoxylated polyethyleneimines such as polyethylene imine ethoxylate, polyethylene imine ethoxylate/propoxylate, and the like.

Exemplary peroxy compounds include organic peracids or peracidic salts of organic acids, such as phthalimidopercaproic acid, perbenzoic acid or salts of diperdodecanedioic acid, hydrogen peroxide and inorganic salts that release hydrogen peroxide under the washing conditions, such as perborate, percarbonate and/or persilicate. Hydrogen peroxide may also be produced with the assistance of an enzymatic system, i.e. an oxidase and its substrate. Other possible peroxy compounds include alkali metal percarbonates, alkali metal perborate monohydrates, alkali metal perborate tetrahydrates or hydrogen peroxide.

Peroxy compounds may be present in the liquid detergent composition in an amount of about 0 to about 10 wt % based on the total weight of the liquid detergent composition.

In an embodiment, the components of the liquid detergent composition are combined and mixed together with a mixer. Once mixed, the composition is encapsulated in a container as described herein. The components of the liquid detergent composition may all be mixed at one time, or different components may be pre-mixed and then combined. A wide variety of mixers may be used in alternate embodiments, such as an agitator, an in-line mixer, a ribbon blender, an emulsifier, and others. The composition is placed in a container, and then the film of the container is sealed with a sealer, where the sealer may utilize heat, water, ultrasonic techniques, water and heat, pressure, or other techniques for sealing the container and forming the unit dose pack.

### Unit Dose Detergent Pack

The unit dose detergent pack comprises a pouch formed from a water-soluble or water-dispersible film enclosing the liquid detergent composition. The pouch is generally a container having one or more chambers (also referred to as compartments) fully enclosing material within the chamber. In one embodiment, the unit dose detergent pack comprises a pouch having a single chamber. In another embodiment, the unit dose detergent pack comprises a pouch having two chambers. In the embodiments where there are two or more chambers, at least one of the chambers fully encloses the liquid detergent composition while the remaining chambers contain one or more additional ingredients as described herein.

The pouch formed from a water-soluble or water-dispersible film may be in any desirable shape and size, e.g., square, rectangular, oval, elliptoid, superelliptical, or circular shape.

The water-soluble or water-dispersible film can be polyvinyl alcohol (PVOH), polyvinyl acetate (PVA), film forming cellulosic polymer, polyacrylic acid, polyacrylamide, polyanhydride, polysaccharide, polyvinyl pyrrolidone, polyalkylene oxide (e.g., polyethylene oxide), cellulose, cellulose ether, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, hydroxyethyl cellulose, maltodextrin, polymethacrylate, polyvinyl alcohol copolymer, hydroxypropyl methyl cellulose (HPMC), or a combination thereof.

In an embodiment, the water-soluble or water-dispersible film material is polyvinyl alcohol (PVOH) or polyvinyl acetate (PVA), specifically polyvinyl alcohol.

In some embodiments, the water-soluble or water-dispersible film may further contain a cross-linking agent. Exemplary cross-linking agents include boric acid or sodium borate.

The thickness of the water-soluble or water-dispersible film used to prepare the pouch enclosing the liquid detergent composition may be about 50 to about 120 micrometers thick, specifically about 60 to about 100 micrometers thick.

The pouch formed from a water-soluble or water-dispersible polymer may be prepared via molding, casting, extruding, blowing, or other suitable process, then filled with a liquid material using an automated filling process, and then sealed.

In an embodiment, the liquid detergent composition is free of colorants and fragrance. In a further embodiment, liquid detergent composition is hypoallergenic and free of colorants and fragrance.

The unit dose detergent pack is suitable for cleaning fabrics, dishes, or other household or industrial items. In an embodiment, the unit dose detergent pack can provide fabric care benefits or sensorial benefits, such as a fragrance booster, softening, malodor control, whitening, color protection, or a combination thereof, to fabrics.

In an embodiment, unit dose detergent pack is formulated and configured for use in a laundry washing machine or a dishwashing machine, for home use or industrial use.

The following examples are merely illustrative of one or more embodiments disclosed herein and are not intended to limit the scope thereof.

### EXAMPLES

### Example 1. Formulations

Formula 1 was a base liquid detergent formulation used to create a design of experiments (20% of the formula withheld) to show optimal levels of Glycerol, Propylene Glycol (PG), polyethylene glycol, grade 400 (PEG 400), and Sorbitol in a unit dose system. The ingredients of Formula 1 are reported in Table 1.

TABLE 1

| COMPONENT | Activity % | Wt % |
|---|---|---|
| Glycerol | 99+% | 14.74 |
| C12-C15 alcohol ethoxylate | 99+% | 23.07 |
| Propylene Glycol | 99+% | 0.00 |
| PEG400 | 99+% | 0.00 |
| Monethanolamine | 99+% | 4.80 |
| Water | 100 | 4.50 |
| Optical brightener, bittering agent, chelating agent | N/A | 2.08 |
| Linear alkylbenzene sulfonate | 96 | 17.00 |
| Coconut Fatty Acid | 100 | 6.00 |
| Sodium laureth sulfate, 3EO - 70% Paste | 70 | 4.80 |
| SDA-3C Ethanol (200 Proof) | 100 | 3.00 |
| [Hole] | | 20.00 |
| Total | | 100.00 |

Liquid detergent formulations Formulas 2-12 were created from a set amount of Formula 1 and varying amounts of PEG 400, Propylene Glycol, and Sorbitol. Each of the PEG 400, Propylene Glycol, and Sorbitol were added as 70% solutions in water. Formulas 2-12 are provided in Table 2.

TABLE 2

| | % Formula | | | | |
|---|---|---|---|---|---|
| | | PEG 400 | Propylene | Sorbitol | |
| | | (70% | Glycol (70% | (70% | |
| | | Solution | Solution | Solution | |
| | Formula 1 | in Water) | in Water) | in Water) | Total |
| Formula 2 | 80.00 | 20.00 | 0.00 | 0.00 | 100 |
| Formula 3 | 80.00 | 0.00 | 20.00 | 0.00 | 100 |
| Formula 4 | 80.00 | 0.00 | 0.00 | 20.00 | 100 |
| Formula 5 | 80.00 | 10.00 | 10.00 | 0.00 | 100 |
| Formula 6 | 80.00 | 0.00 | 10.00 | 10.00 | 100 |
| Formula 7 | 80.00 | 10.00 | 0.00 | 10.00 | 100 |
| Formula 8 | 80.00 | 6.67 | 6.67 | 6.67 | 100 |
| Formula 9 | 80.00 | 3.33 | 3.33 | 13.33 | 100 |
| Formula 10 | 80.00 | 3.33 | 13.33 | 3.33 | 100 |
| Formula 11 | 80.00 | 13.33 | 3.33 | 3.33 | 100 |
| Formula 12 | 80.00 | 8.29 | 11.71 | 0.00 | 100 |

The weight ratios of PEG 400, Propylene Glycol, and Sorbitol in Formulas 2-12 are provided in Table 3.

TABLE 3

| Formula | PEG 400 | Propylene Glycol | Sorbitol |
|---|---|---|---|
| Formula 2 | 1 | 0 | 0 |
| Formula 3 | 0 | 1 | 0 |
| Formula 4 | 0 | 0 | 1 |
| Formula 5 | 0.5 | 0.5 | 0 |
| Formula 6 | 0 | 0.5 | 0.5 |
| Formula 7 | 0.5 | 0 | 0.5 |
| Formula 8 | 0.333 | 0.333 | 0.333 |
| Formula 9 | 0.167 | 0.167 | 0.667 |
| Formula 10 | 0.167 | 0.667 | 0.167 |
| Formula 11 | 0.667 | 0.167 | 0.167 |
| Formula 12 | 0.414 | 0.586 | 0 |

### Example 2. Swelling Tests for Film Used in Unit Dose Packs

To determine compatibility with polyvinyl alcohol (PvOH) film used to encapsulate the liquid in unit dose detergent packs, strips of PvOH were submerged in a sample liquid formulation for approximately 24 hours. The initial strip weight was measured as well as the post-weight after wiping excess liquid off the strip. “% swelling”, or swelling ratio, was measured by taking the post-weight, subtracting the pre-weight and then dividing by the pre-weight. A lower swelling ratio is preferred.

TABLE 4

| | | | | Pre-Weight | | | | Post-Weight | |
|---|---|---|---|---|---|---|---|---|---|
| | Pre-weight | | | Average | Post-weight | | | Average | % |
| Formula | (grams) | | | (grams) | (grams) | | | (grams) | Swelling |
| 2 | 0.214 | 0.234 | 0.232 | 0.227 | 0.264 | 0.248 | 0.257 | 0.256 | 13.2% |
| 3 | 0.236 | 0.232 | 0.222 | 0.230 | 0.291 | 0.294 | 0.275 | 0.293 | 27.4% |
| 4 | 0.225 | 0.238 | 0.225 | 0.229 | 0.289 | 0.276 | 0.273 | 0.275 | 19.9% |
| 5 | 0.219 | 0.225 | 0.230 | 0.224 | 0.255 | 0.263 | 0.273 | 0.264 | 17.6% |
| 6 | 0.228 | 0.239 | 0.234 | 0.233 | 0.294 | 0.275 | 0.293 | 0.293 | 25.7% |
| 7 | 0.238 | 0.230 | 0.222 | 0.230 | 0.275 | 0.284 | 0.267 | 0.275 | 19.6% |
| 8 | 0.223 | 0.225 | 0.238 | 0.229 | 0.275 | 0.274 | 0.287 | 0.279 | 21.8% |
| 9 | 0.232 | 0.222 | 0.228 | 0.227 | 0.267 | 0.286 | 0.274 | 0.276 | 21.3% |
| 10 | 0.242 | 0.230 | 0.230 | 0.234 | 0.293 | | 0.281 | 0.287 | 22.7% |
| 11 | 0.233 | 0.222 | 0.239 | 0.231 | 0.263 | 0.276 | 0.282 | 0.279 | 20.6% |
| 12 | 0.209 | 0.223 | 0.226 | 0.220 | 0.279 | 0.261 | 0.273 | 0.276 | 25.5% |

Using Minitab statistics software to analyze the swelling results, the following Analysis of Variance for % Swelling (Table 5.) and Estimated Regression Coefficients for % Swelling (Table 6.) were observed.

TABLE 5
Analysis of Variance for % Swelling (component proportions)

| | | | | | F- | P- |
|---|---|---|---|---|---|---|
| Source | DF | Seq SS | Adj SS | Adj MS | Value | Value |
| Regression | 5 | 0.028735 | 0.028735 | 0.005747 | 4.00 | 0.008 |
| Linear | 2 | 0.027158 | 0.024705 | 0.012352 | 8.60 | 0.001 |
| Quadratic | 3 | 0.001576 | 0.001576 | 0.000525 | 0.37 | 0.778 |
| PEG 400*PG | 1 | 0.000266 | 0.000329 | 0.000329 | 0.23 | 0.636 |
| PEG | 1 | 0.001281 | 0.001285 | 0.001285 | 0.89 | 0.353 |
| 400*Sorbitol | | | | | | |
| PG*Sorbitol | 1 | 0.000029 | 0.000029 | 0.000029 | 0.02 | 0.888 |
| Residual Error | 26 | 0.037360 | 0.037360 | 0.001437 | | |
| Lack-of-Fit | 5 | 0.003603 | 0.003603 | 0.000721 | 0.45 | 0.810 |
| Pure Error | 21 | 0.033757 | 0.033757 | 0.001607 | | |
| Total | 31 | 0.066095 | | | | |

TABLE 6
Estimated Regression Coefficients for
% Swelling (component proportions)

| Term | Coef | SE Coef | T-Value | P-Value | VIF |
|---|---|---|---|---|---|
| PEG 400 | 0.1313 | 0.0211 | * | * | 2.11 |
| PG | 0.2492 | 0.0212 | * | * | 2.17 |
| Sorbitol | 0.2182 | 0.0211 | * | * | 1.95 |
| PEG 400*PG | 0.0406 | 0.0849 | 0.48 | 0.636 | 2.33 |
| PEG 400*Sorbitol | 0.0914 | 0.0967 | 0.95 | 0.353 | 1.95 |
| PG*Sorbitol | −0.0137 | 0.0963 | −0.14 | 0.888 | 1.86 |

Overall, the model was significant (p value less than 0.05). The estimated regression coefficient for % Swelling showed that PEG 400 impacts the film material the least (0.1313 vs. 0.2492 for Propylene Glycol and 0.2182 for Sorbitol); with a smaller value being more desirable. These values also include the impact of Glycerol in the system, which was used at a fixed level. Sorbitol exhibited lower film impact than Propylene Glycol.

In terms of compatibility with the pack film, it would be most desirable for PEG 400 to be the only solvent in the system, but PEG 400 traditionally costs more than Glycerol and Sorbitol and is often sourced from non-renewable materials, unlike Sorbitol. Additionally, depending upon the manufacturing process, PEG 400 may contain residual 1,4 dioxane, a possible human carcinogen and persistent compound, whereas Sorbitol and Glycerol typically do not. Therefore, a blend of Sorbitol, Glycerol, and PEG 400 provides benefits in terms of pack film compatibility, low cost, and increased use of sustainable ingredients, while also limiting the presence of 1,4 dioxane without the need of Propylene Glycol, a known allergen.

When taking a cost ratio of 2:1 into account for PEG 400 or Propylene Glycol to Sorbitol (sorbitol is traditionally cost effective versus PEG 400 and Propylene Glycol), the model recommends a 60/40 to 50/50 ratio of Sorbitol/PEG 400 and eliminates Propylene Glycol from the formulation.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “+10%” means that the indicated measurement can be from an amount that is minus 10% to an amount that is plus 10% of the stated value. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A unit dose detergent pack, comprising:
a pouch formed from a water-soluble or water-dispersible film; and
a liquid detergent composition free of propylene glycol and releasably disposed within the pouch, the liquid detergent composition comprising:
a detergent surfactant system in an amount of about 10 to about 60 wt %;
water in an amount of about 5 to about 35 wt %; and
a non-aqueous solvent system comprising
a C₄₋₁₂ alditol in an amount of about 3 to about 20 wt %,
a polyethylene glycol having a number average molecular weight of from about 100 to about 1500 Daltons in an amount of about 3 to about 35 wt %, and
glycerol in an amount of about 0 to about 20 wt %,
wherein all amounts are based on the total weight of the liquid detergent composition, and
the C₄₋₁₂ alditol and the polyethylene glycol are present in a weight ratio of about 10:90 to about 90:10.

2. The unit dose detergent pack of claim 1, wherein the C₄₋₁₂ alditol is sorbitol, adonitol (ribitol), arabitol, dulcitol (galactitol), erythritol, inositol, isomalt, maltitol, mannitol, xylitol, or a combination thereof.

3. The unit dose detergent pack of claim 1, wherein the C₄₋₁₂ alditol is sorbitol.

4. The unit dose detergent pack of claim 1, wherein the C₄₋₁₂ alditol comprises no reducing sugars or substantially no reducing sugars.

5. The unit dose detergent pack of claim 1, wherein the C₄₋₁₂ alditol is present in an amount of about 5 to about 15 wt % based on the total weight of the liquid detergent composition.

6. The unit dose detergent pack of claim 1, wherein the polyethylene glycol is present in an amount of about 5 to about 15 wt % based on the total weight of the liquid detergent composition.

7. The unit dose detergent pack of claim 1, wherein the glycerol is in an amount of about 5 to about 16 wt % based on the total weight of the liquid detergent composition.

8. The unit dose detergent pack of claim 1, wherein the glycerol and the combined weight of the C₄₋₁₂ alditol and the polyethylene glycol are in a weight ratio of about 60:40 to about 40:60.

9. The unit dose detergent pack of claim 1, wherein the detergent surfactant system comprises a non-ionic surfactant, an anionic surfactant, or a combination of a non-ionic surfactant and an anionic surfactant.

10. The unit dose detergent pack of claim 1, wherein the non-ionic surfactant is an alcohol alkoxylate.

11. The unit dose detergent pack of claim 1, wherein the anionic surfactant is a polyethoxylated alcohol sulfate or a linear alkyl benzene sulfonic acid.

12. The unit dose detergent pack of claim 1, wherein the detergent surfactant system is present in an amount of about 20 to about 50 wt % based on the total weight of the liquid detergent composition.

13. The unit dose detergent pack of claim 1, wherein the liquid detergent composition further comprises one or more additional ingredient that is an antimicrobial agent, an anti-redeposition agent, a biodegradable polymer, a bittering agent, a bleach activator, a chelating agent, a colorant, an enzyme, a foam inhibitor, a fragrance, a neutralizer, an optical brightener, a performance polymer, a peroxy compound, a soil releasing polymer, a whitener, or a combination thereof.

14. The unit dose detergent pack of claim 1, wherein the liquid detergent composition is free of colorants and fragrance.

15. The unit dose detergent pack of claim 1, wherein the water-soluble or water-dispersible film material is polyvinyl alcohol or polyvinyl acetate.

16. The unit dose detergent pack of claim 1, formulated and configured for use in a laundry washing machine or a dishwashing machine.

17. A unit dose detergent pack, comprising:
a pouch formed from a polyvinyl alcohol film; and
a liquid detergent composition free of propylene glycol and releasably disposed within the pouch, the liquid detergent composition comprising:
a detergent surfactant system in an amount of about 10 to about 60 wt %;
water in an amount of about 5 to about 25 wt %; and
a non-aqueous solvent system comprising
sorbitol in an amount of about 3 to about 20 wt %,
a polyethylene glycol having a number average molecular weight of from about 200 to about 800 Daltons in an amount of about 3 to about 35 wt %, and
glycerol in an amount of about 0 to about 20 wt %,
wherein all amounts are based on the total weight of the liquid detergent composition, and
the sorbitol and the polyethylene glycol are present in a weight ratio of about 10:90 to about 90:10.

18. The unit dose detergent pack of claim 17, wherein the polyethylene glycol has a number average molecular weight of about 400 Daltons.

19. The unit dose detergent pack of claim 17, wherein the liquid detergent composition is free of colorants and fragrance.

20. The unit dose detergent pack of claim 17, wherein the sorbitol comprises no reducing sugars or substantially no reducing sugars.
